(19) United States
(12) Patent Application Publication
(10) Pub. No.: US 2023/0272184 A1
(43) Pub. Date: Aug. 31, 2023

(54) Ultra-Low Wear Magnetic Polymer Composite

(71) Applicants: National Technology & Engineering Solutions of Sandia, LLC, Albuquerque, NM (US); Lehigh University, Bethlehem, PA (US)

(72) Inventors: Tomas Farley Babuska, Albuquerque, NM (US); Andrew Kustas, Elizabeth, CO (US); Tomas Grejtak, Bethlehem, PA (US)

(21) Appl. No.: 18/133,826

(22) Filed: Apr. 12, 2023

Related U.S. Application Data
(60) Provisional application No. 63/330,194, filed on Apr. 12, 2022.

(51) Int. Cl. C08K 3/11; C08F 114/26

(52) U.S. Cl. CPC C08K 3/11; C08F 114/26

(57) ABSTRACT

Polytetrafluoroethylene filled with FeCo microparticles provides an ultralow wear, magnetic, multifunctional tribological material. For example, PTFE filled with an 5 wt. % of equiatomic, prealloyed FeCo powder resulted in steady state wear rates of 2.7×10⁻⁷ mm³/Nm, approaching that of PTFE-filled alumina. Comparable wear rates were not recovered for PTFE filled with just iron or cobalt microparticles.

### CROSS-REFERENCE TO RELATED APPLICATION

This application claims the benefit of U.S. Provisional Application No. 63/330,194, filed Apr. 12, 2022, which is incorporated herein by reference.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### STATEMENT REGARDING PRIOR DISCLOSURES BY THE INVENTOR OR A JOINT INVENTOR

The following disclosure is submitted under 35 U.S.C. 102(b)(1)(A): Kylie E. Van Meter, Tomas F. Babuska, Christopher P. Junk, Kasey L. Campbell, Mark A. Sidebottom, Tomas Grejtak, Andrew B. Kustas, and Brandon A. Krick, “Ultralow Wear Behavior of Iron-Cobalt-Filled PTFE Composites,” Tribology Letter 71 (1), 4 (2023). Published online: 25 Nov. 2022. The subject matter of this disclosure was conceived of or invented by the inventors named in this application.

### FIELD OF THE INVENTION

The present invention relates to polymer composites and, in particular, to ultra-low wear magnetic polymer composites.

### BACKGROUND OF THE INVENTION

Polytetrafluoroethylene (PTFE) is a desirable material for tribological applications due to its low friction coefficient (μ˜0.1), low surface energy, and large temperature operation ranges. See M. M. Renfrew and E. E. Lewis, Ind. Eng. Chem. 38 (9), 870 (1946); C. W. Bunn et al., J. Polym. Sci. 28 (117), 365 (1958); C. W. Bunn and E. R. Howells, Nature 174 (4429), 549 (1954); K. V. Shooter and D. Tabor, Proc. Phys. Soc. Sect. B 65 (9), 661 (1952); and G. J. Puts et al., Chem. Rev. 119 (3), 1763 (2019). During sliding, PTFE adheres to the countersurface, creating a “transfer film” that allows for a low shear-strength interface. See S. Bahadur and D. Tabor, Wear 98 (C), 1 (1984); S. K. Biswas and K. Vijayan, Wear 158 (1-2), 193 (1992); K. R. Makinson and D. Tabor, Nature 201 (4918), 464 (1964); K. Tanaka et al., Wear 23 (2), 153 (1973); and T. A. Blanchet and F. E. Kennedy, Wear 153 (1), 229 (1992). However, unfilled PTFE exhibits high wear rates on the order of 10⁻⁴ mm³/Nm due to large-scale delamination wear of the polymer and instability/poor adhesion of the transfer film to the countersurface. Improvements in the wear rate ranging from 100× to 100,000x× have been observed when adding filler materials to PTFE, while still maintaining low friction coefficients (μ<0.2) and many of its desirable material properties. See K. Tanaka, Compos. Mater. Ser. 1 (C), 137 (1986); D. L. Burris and W. G. Sawyer, Wear 260, 915 (2006); B. A. Krick et al., Tribol. Int. 51, 42 (2021); B. A. Krick et al., Tribol. Trans. 57 (6), 1058 (2014); B. A. Krick et al., Tribol. Int. 95, 245 (2016); D. L. Burris et al., Macromol. Mater. Eng. 292 (4), 387 (2007); K. E. Van Meter et al., Macromolecules 55 (10), 3924 (2022); A. A. Pitenis et al., Tribol. Lett. 53 (1), 189 (2013); K. L. Harris et al., ACS Macromol. 48 (11), 3739 (2015); H. S. Khare et al., J. Phys. Chem. C 119 (29), 16518 (2015); D. L. Burris and W. G. Sawyer, Wear 262 (1-2), 220 (2007); D. L. Burris et al., Wear 267, 653 (2009); D. L. Burris and W. G. Sawyer, Wear 261 (3-4), 410 (2006); K. L. Campbell et al., Macromolecules 52 (14), 5268 (2019); and A. A. Pitenis et al., Tribol. Lett. 57 (1), 1 (2015).

The addition of alpha-alumina fillers to PTFE and PTFE-PEEK with concentrations as low as 0.13% have been shown to reduce the wear rates of PTFE-alumina composites to ˜1×10⁻⁷ mm³/Nm and PTFE-PEEK-alumina composites to ˜4×10⁻⁸. See D. L. Burris et al., Wear 267, 653 (2009); and K. I. Alam et al., Wear 482-483, 203965 (2021). Reduction in wear rate with the addition of alumna nanoparticles has been attributed to the nanoscale aggregate structure of micron-sized particles that can break up due to high-pressure asperity contacts at the sliding surface. See B. A. Krick et al., Tribol. Int. 95, 245 (2016). Nanoscale filler fragments have been shown to accumulate at the sliding interface, creating a mechanically harder, chemically altered, reinforced transfer film and running film. See B. A. Krick et al., Tribol. Trans. 57 (6), 1058 (2014). Furthermore, particle size has been shown to be an important variable as microscale fillers can impart larger improvements in wear rate than their nano counterparts by arresting sub-surface cracks and preventing delamination. See B. A. Krick et al., Tribol. Int. 95, 245 (2016); and S. Bhargava and T. A. Blanchet, J. Tribol. 138 (4)M, 042001 (2016). Particle size needs to be balanced with particle friability, with studies by Krick et al. showing that highly dense alumina microparticles with high hardness can inhibit the formation of the transfer film by abrading the countersurface. See B. A. Krick et al., Tribol. Int. 95, 245 (2016); and S. E. McElwain et al., Tribol. Trans. 51 (3), 247 (2008).

Understanding the effects of filler particle size and mechanical properties on PTFE-alumina composites can give insight into desirable properties of fillers to create other ultralow wear PTFE composites. As sliding-induced shear drives filler particle fragmentation and chain scission of PTFE polymer chains, tribochemistry at the sliding interface driven by bonding of carboxylic end groups to the metallic oxides of the filler material results in ultralow wear rate PTFE-alumina composites. See B. A. Krick et al., Tribol. Trans. 57 (6), 1058 (2014). However, the ultralow wear rates observed in metal-filled PTFE composites suggest that the presence of oxide fillers is not required for ultralow wear. In recent studies by Ullah et al., PTFE filled with titanium, chromium, and manganese microparticles slid against brass exhibited ultralow wear rates (2×10⁻⁹-2×10⁻⁷ mm³/Nm). See S. Ullah et al., Wear 498-499, 204338 (2022). Bronze is the most commonly used metallic filler in PTFE composites for industrial applications. High weight percent (40-60%) bronze fillers in PTFE are used in linear bearing applications and exhibit wear rates of ˜3×10⁻⁷ mm³/Nm. See T. A. Blanchet and F. E. Kennedy, Wear 153 (1), 229 (1992); D. D. Tabor, “Friction, Lubrication, and Wear,” in Mechanical Design Handbook, McGraw-Hill (2006); G. E. Totten ed., ASM Handbook, Volume 18: Friction, Lubrication, and Wear Technology, (2017); B. Aldousiri et al., Adv. Mater. Sci. Eng. (2013); C. A. G. S. Valente et al., Tribol. Trans. 63 (2), 356 (2020); M. Trabelsi et al., Trans. Indian Inst. Met. 69 (5), 1119 (2016); M. J. Khan et al., Int. J. Surf. Sci. Eng. 12 (5-6), 348 (2018); Y. Wang and F. Yan, Wear 262 (7-8), 876 (2007); and H. Unal et al., J. Reinf. Plast. Compos. 29 (14), 2184 (2009). PTFE-bronze has excellent thermal conductivity but low electrical conductivity and has no intrinsic magnetic properties.

However, a need remains for ultralow wear polymer composites made with magnetic or electrically conductive filler materials.

### SUMMARY OF THE INVENTION

The present invention is directed to a magnetic polymer composite, comprising magnetic alloy particles dispersed in a perfluoropolymer matrix. The composite can comprise between about 1 and about 50 wt. % magnetic alloy particles. The size of the magnetic alloy particles can be less than 100 μm and greater than about 100 nm. For low wear, the particles can be brittle and have a low fracture toughness, with a low yield strength and low strain-to-failure. For example, the magnetic alloy can be an Fe—Co intermetallic alloy and the perfluoropolymer can be polytetrafluoroethylene.

### BRIEF DESCRIPTION OF THE DRAWINGS

The detailed description will refer to the following drawings, wherein like elements are referred to by like numbers.

FIG. 1A is an SEM secondary electron image of the cobalt (Co) filler powder. FIG. 1B is an SEM secondary electron image of the iron (Fe) filler powder. FIG. 1C is an SEM secondary electron image of the iron-Cobalt (FeCo) filler powder. FIG. 1D is a graph of particle diameter distributions measured by laser diffraction and computed as volume and number weighted differential distributions. FIG. 1E is a graph of particle diameter cumulative distributions. Observed SEM primary feature size and vendor-reported particle size are indicated on the distribution curves. FIG. 1F is a table of legend and particle size statistics, including 10th, 50th, and 90th percentiles and mean for (i-iii) volume-based diameter distributions and (iv-vi) number-based diameter distributions. Relative size and morphology of Co, Fe, and FeCo particles is illustrated.

FIG. 2 is a schematic illustration of a on flat sample configuration, demonstrating a polymer pin sliding against a stainless steel counter sample with an applied normal load F_{N}, stroke length S, and reciprocating velocity V.

FIG. 3A is a bar graph of steady-state wear rates for unfilled PTFE, and PTFE filled with 5 wt. % Fe, 5 wt. % Co, and 5 wt. % FeCo. Steady-state wear was calculated using a four-point fit during the linear region of volume loss for each sample. Error bars are the uncertainty of the calculation. It should be noted that the error bars are not very visible because wear rate uncertainty for each sample is one or more orders of magnitude smaller than the measurement itself. FIG. 3B is a bar graph of average friction coefficient in the steady-state wear region for unfilled PTFE, and PTFE filled with 5 wt. % Fe, 5 wt. % Co, and 5 wt. % FeCo. Error bars indicate the standard deviation of the friction coefficient over the averaged region.

FIG. 4A is a graph of volume loss V of unfilled PTFE, and PTFE filled with 5 wt. % Fe, 5 wt. % Co, and 5 wt. % FeCo over the sliding distance. FIG. 4B is a graph of incremental wear rate of unfilled PTFE, 5 wt. % Fe, 5 wt. % Co, and 5 wt. % FeCo.

FIG. 5A is a graph of volume loss V of unfilled PTFE, and PTFE filled with 5 wt. % Fe, 5 wt. % Co, and 5 wt. % FeCo over the applied normal force times sliding distance, F_{N}d. Fe and Co composite samples were stopped at 2.5 km of sliding due to extremely high wear volume. FIG. 5B is a graph of volume loss of 5 wt. % FeCo sample over total distance travelled. Plotted line indicates region in which steady state wear was calculated (units in mm³/Nm).

FIG. 6 is a graph of friction coefficient over the sliding distance of the experiment. Friction coefficient was determined at each point by averaging the friction at logarithmically increasing meters of sliding.

FIG. 7A is a photograph of a transfer film deposited on 304 SS counter sample for PTFE 5 wt. % Fe. FIG. 7B is a photograph of a transfer film for PTFE 5 wt. % Co. FIG. 7C is a photograph of a transfer film for PTFE 5 wt. % FeCo. FIG. 7D shows profilometry of transfer films on counter sample.

FIG. 8A shows ATIR spectra of the worn polymer surface of the Fe, Co, and FeCo composites. FIG. 8B shows reflectance IR spectra of the polymer transfer films on surface of the stainless steel counter sample.

### DETAILED DESCRIPTION OF THE INVENTION

The invention is directed to a magnetic polymer composite, comprising magnetic alloy particles dispersed in a perfluoropolymer matrix. The magnetic alloy can be a brittle intermetallic material having a low strain to failure or low fracture toughness. For example, the magnetic alloy can be an iron-cobalt intermetallic alloy. The iron-cobalt alloy can have a range of compositions, for example, from Fe_{0.3}Co_{0.7} to Fe_{0.7}Co_{0.3}. The Fe—Co alloy can be further alloyed with additional elements, such as vanadium, chromium, niobium, molybdenum, and/or nickel. The size of the magnetic alloy particles can be less than 100 μm and greater than about 100 nm. The composite can comprise between about 1 and about 50 wt. % magnetic alloy. A variety of perfluoropolymers can be used, including PTFE, fluorinated ethylene-propylene (FEP), polychlorotrifluoroethylene (PCTFE), or perfluoroalkoxy alkane (PFA), the latter of which can be injection molded.

Iron-cobalt (FeCo) alloys are electrically conductive and, depending on the ratio of Fe to Co, have the highest mean atomic moment, and thus magnetization saturation, of any commercially available material soft magnetic alloy. For example, Fe-50Co (referred to hereafter as FeCo) has a high saturation induction (Bₘₐₓ˜2.4 T) while retaining high permeability (˜8×10³) and low coercivity (˜100 A/m), magnetic properties that are well suited for a range of electromagnetic applications, such as motors, transformers, and solenoids. See R. S. Sundar and S. C. Deevi, Int. Mater. Rev. 50 (3), 157 (2005); T. Sourmail, Prog. Mater. Sci. 7, 816 (2005); and A. B. Kustas et al., Addit. Manuf. 21 (1), 41 (2018). However, FeCo alloys, especially at the near-equiatomic composition, are brittle (<5% strain to fracture in tension) due to disorder-order phase transformation, making them difficult to process in bulk form and use in mechanically demanding applications unless alloyed with other elements, like vanadium, chromium, or niobium, among others. See K. Kawahara, J. Mater. Sci. 18 (6), 1709 (1983). The alloying of other elements with FeCo improves the mechanical properties but decreases some of the desirable magnetic properties. For instance, FeCo alloys with a modest 3% niobium addition can exhibit >10% lower saturation magnetization and >600% higher coercivity compared to binary FeCo. See T. Sourmail, Prog. Mater. Sci. 7, 816 (2005). For tribological fillers, however, brittle material properties can be advantageous in the development of transfer films through the breakdown and accumulation of the filler material at the sliding interface. The combination of brittle material properties with the magnetic and electrical properties of FeCo presents an interesting multi-faceted tribological filler material for perfluoropolymer composites.

As an example of the invention, Fe_{0.5}Co_{0.5} microparticles were used to create a PTFE-FeCo composite. Three polymer composite samples were prepared, PTFE filled with: 5 wt. % FeCo, 5 wt. % Fe, and 5 wt. % Co. Powders consisting of alloyed equiatomic Fe_{0.5}Co_{0.5} (particle size 45±15 um), Fe (325 mesh, ˜44 um particle size) and Co (1-5 um particle size) were used. To create the composite powder mixture, the dry powder components were combined and isopropyl alcohol (IPA) was added in a 5:1 (IPA to powder) ratio by mass. The solutions were mixed to form a slurry, the slurry was sonicated, and the IPA was allowed to evaporate from the sonicated composite powders.

After drying,10g of composite powder was placed in a 12.7 mm diameter 440 C stainless steel cylindrical mold and compressed to 30 MPa using a hydraulic press at room temperature. The molded cylinder was then wrapped in aluminum foil and free sintered in an oven, ramping from room temperature to 380° C. at 2° C./min, with a dwell at 380° C. for three hours, and cooled at 2° C./min to room temperature. The free sintered cylinder was machined into a 12.7×6.35×6.35 mm polymer pin. Prior to testing, each pin was sonicated in methanol for 30 minutes and allowed to air dry. The countersample used in testing consisted of a 304 stainless steel coupon (0.1875″×1″×1.5″) that was polished to a mirror finish.

### Filler Particle Size and Morphology

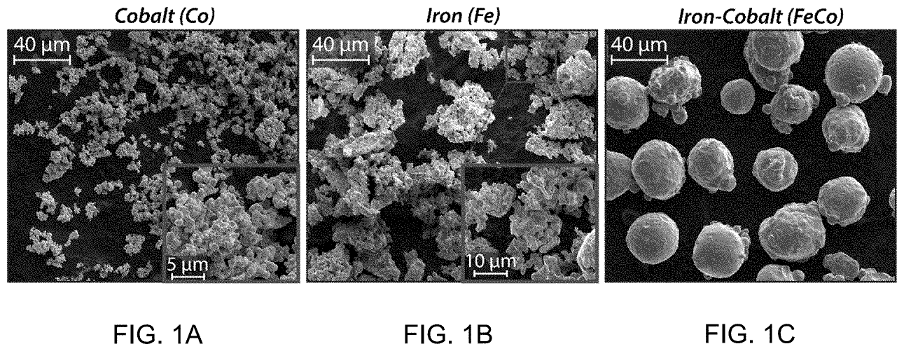

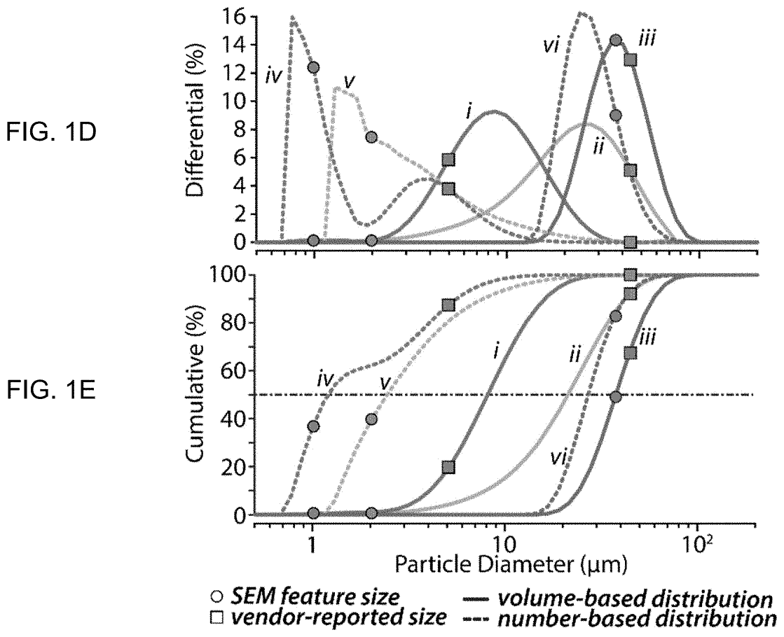

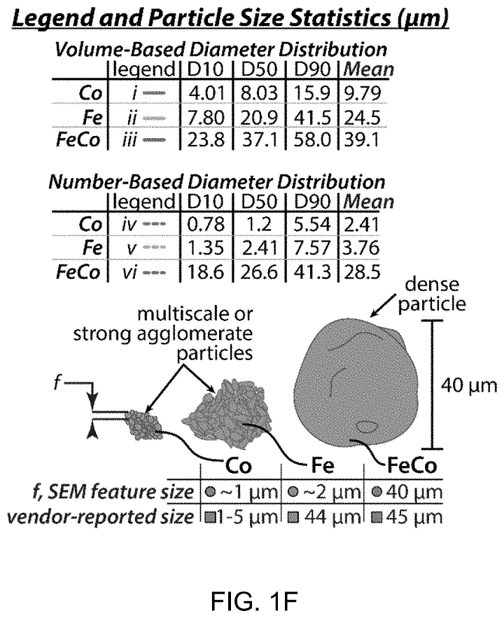

The iron (Fe), cobalt (Co), and iron-cobalt powders were imaged using a scanning electron microscope (SEM) with a secondary electron detector to visualize particle size and morphology, as shown in FIGS. 1A-1C. The Fe powder appears to have large particles of about 10⁻⁴⁰ μm in size (FIG. 1B). Upon closer inspection, the particles appear to have a smaller, irregularly shaped feature size of approximately 1-2 μm; it is possible that this is a strongly fused agglomerate of smaller particles. The Co powder has smaller bulk particles in the 5-15 μm range (FIG. 1A), which also appear to have a smaller feature size that are more spherical in shape and smaller than the Fe particle features, ranging from 1 μm down to larger nanoscale particles (order 700 nm). In contrast, the FeCo powder particles are large, in the 20-50 μm range, and are uniform and spherical (FIG. 1C). There appear to be very few small (5-10 μm) features on the surface of the large particles, and the overall bulk particle shape is uniform.

Laser diffraction results support the particle size and morphology observed in the SEM images, As shown in FIGS. 1D and 1E. Volume-based (FIG. 1F: i-iii) and number-based (FIG. 1F: iv-vi) diameter differential distribution (i.e., probability distribution; FIG. 1D) and cumulative distribution (i.e., cumulative probability; FIG. 1E) were computed. Both the differential and cumulative distributions show that based on volume, the mean, median, and mode particle size is measured to be larger than the same values calculated based on particle number (FIGS. 1D and 1E). The shift in the Co and Fe distribution curves demonstrate that while by volume the median particle size is ˜8 and 20 μm (respectively), there are a high number of small diameter, low volume particles present. This causes the Co and Fe median particle diameter to shift to 1.2 and 2.4 μm (respectively). These number-weighted values coincide with the primary feature size observed in SEM. The FeCo powder number-based distribution is also shifted slightly to smaller particle diameters, but the distribution shape is remarkably similar to the volume-based distribution, most likely due to the more uniform particle shape and size observed in SEM and the lack of many small particles/features.

The differential volume density distribution of the Fe powder spans across a wide range of particle sizes (1-80 μm) (FIGS. 1D and 1F). The mean volume weighted particle size was calculated to be 24.5 μm. Only 10% of the volume of particles are smaller than 7.80 μm, and less than 0.5% of the powder volume has particles smaller than 2 μm (FIG. 1E: ii). However, by number, ˜50% of the particles fall below 2 μm (FIG. 1F: v), a diameter which is similar to the primary feature size seen in SEM (FIG. 1B). This could indicate that there are a large number of particles that fall into the category of the primary feature size, and that the larger particles could be hard agglomerates of smaller particles. The manufacturer reports a mesh size of 325 (44 μm), and 93% of the particles by volume have diameters which are equal to or less than the value given by the manufacturer. While the manufacturer reports an accurate mesh value that matches the measured cumulative distribution by volume (FIG. 1E: ii), it should be noted that based on a number-weighted distribution, 90% of the particles are less than 7.57 μm, much smaller than the reported value (FIG. 1E: v).

The Co powder also has a differential volume density distribution that spans a broad range of particle sizes, from 0.6 to 35 μm (FIG. 1D). However, the volume density percentiles are more closely grouped, with a mean volume weighted particle size of 9.79 μm and 90% of the powder volume contains particles under 15.9 μm in diameter (FIGS. 1E and 1F). Only 10% volume percent of particles fall below 4 μm in diameter. The manufacturer reports particle sizes in the range of 1-5 μm, but the differential volume density distribution as well as SEM images indicate that the volume weighted average particle size is larger than the value given by the manufacturer; as such, it is hypothesized that the manufacturers use an adsorption method to approximate particle size by measuring the surface area and mass of the particles and approximating them as spherical. See B. A. Krick et al., Tribol. Int. 95, 245 (2016). The Co powder has a second differential peak at around 1 μm that is less visible in the volume-weighted distribution but becomes the primary peak in the number-weighted distribution (FIG. 1F: i,iv). This peak indicates that ˜1% of a given volume of powder contains particles less than 2 μm in size, but that ˜60% of a given number of particles fall into this category. These small particle sizes match the primary features that make up the larger strongly fused agglomerate particles which can be seen using SEM (FIG. 1A). The separation of the peaks at 1 μm and 5 μm could indicate that the cobalt powder is made up of mostly strongly fused larger agglomerates and smaller primary particles, with few particles that fall in between (FIG. 1D: iv).

The FeCo differential volume density distribution includes particles from 12 to 100 μm (FIG. 1D: iii). The powder has a mean volume-weighted particle size of 39 μm with 90% of the a given powder volume having a particle less than 58 μm (FIGS. 1E and 1F: iii). Unlike the Fe and Co powders, the smallest particle sizes of the FeCo particles are on the order of 10 μm, with only 10% of the particles by volume falling below 23.8 μm in size. By number, 90% of particles are less than 41 μm in size, and the mean particle size is 28.5 μm (FIGS. 1E and 1F: vi). This result, along with SEM imaging of the particles, show that the FeCo powder is comprised of micron scale particles that are not agglomerates, but rather dense uniform spherical particles. An illustration of the observed particle morphology and volume-weighted mean particle size is shown in FIG. 1F, where the Fe and Co agglomerate particles are on average 24.5 and 9.79 μm, respectively, and are comprised of micron scale primary features, while the FeCo particles are on average 39 μm in diameter and are uniform, dense spheres. The manufacturer reported size is 45 μm (±15 μm), which appears to be larger than the particles observed in the SEM and the median and mean particle diameter measured with laser diffraction. However, the reported size and range does fall within the volume weighted cumulative distribution.

### Friction and Wear

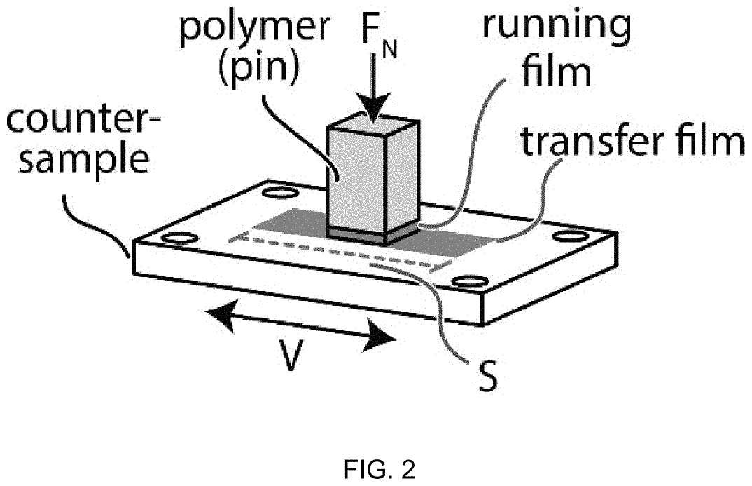

Wear and friction experiments were performed on a bidirectional linearly reciprocating tribometer in a flat-on-flat sample configuration, as shown in FIG. 2. A normal load of 250 N (6.2 MPa) was applied to the polymer composite pin using a ball-screw-driven stage connected to a laterally constrained cantilevered flexure. Applied load and resultant friction force were measured using two decoupled load cells and active servo-on-load was used to maintain constant loading conditions. A ball-screw stage was used to slide the counter sample below the polymer composite pit at a speed of 50 mm/s and a stroke length of 25 mm (50 mm/cycle). Samples underwent sliding for the following cycle intervals: 1 k, 4 k, 5 k, 10 k, 10 k, 10 k, 10 k, 50 k, 100 k, 100 k, 100 k, 100 k, for a total of 500 k cycles (total distance 2.5 km). Due to extremely high wear rates, some samples were only able to be tested up to 50 k total sliding cycles. Sliding experiments were performed in a controlled environment with a relative humidity of 30±1%.

Before testing, each sample was measured with calipers and weighed on a scale to determine material density. After each cycle interval, samples were removed from the tribometer and weighed on the scale. Calculated density (using initial sample dimensions and weight) and subsequent mass loss were used to calculate volume loss of the sample. The wear rate of the sample K was calculated using Eq. 1, where V is the volume loss of sample, F_{N} is the applied load, and d is the sliding distance.

$$K [ {mm}^{3} / Nm ] = \frac{V [ {mm}^{3} ]}{{F}_{N} [ N ] d [ m ]} \qquad ( 1 )$$

Total wear rate Kₜₒₜ was calculated using the total lost volume of the sample and the total sliding distance for the entire experiment lifetime. Incremental wear rates K_{inc} were calculated using the volume loss per test segment and the distance traveled for that test segment. Steady state wear rates Kₛₛ and associated uncertainties were calculated through Monte Carlo simulations. See T. L. Schmitz et al., J. Tribol. 126 (4), 802 (2004); and T. L. Schmitz et al., J. Tribol. 127 (3), 673 (2005). All steady-state wear rates reported were calculated in the regions of linearly increasing volume loss, fitting the Monte Carlo simulations to the final four points of volume loss for each sample. Total wear rate demonstrates the overall performance of the sample, while incremental wear rate shows the performance of the sample as a function of incremental sliding cycles. Steady-state wear rate is determined when the sample reaches linear volume loss behavior.

Friction coefficients and their standard deviations were calculated using methods described in Burris. See D. L. Burris et al., Tribol. Lett. 35 (1), 17 (2009). Friction loops were generated by dividing the measured friction force by the applied normal force throughout each sliding cycle and were used in the calculations for reported friction coefficient.

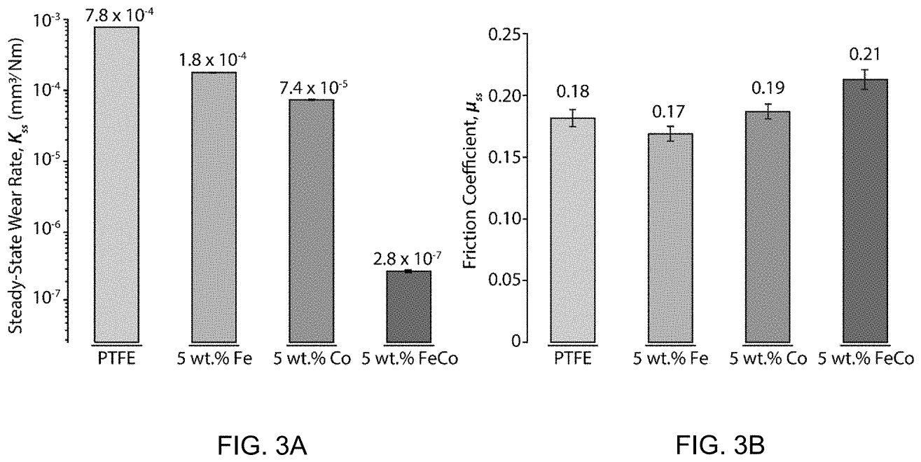

The steady state wear rate of the PTFE 5 wt. % Fe sample was found to be 1.8×10⁻⁴ mm³/Nm with an average friction coefficient of 0.17, as shown in FIGS. 3A and 3B. PTFE 5 wt. % Co achieved a steady state wear rate of 7.4×10⁻⁵ mm³/Nm, ˜2× lower than the wear rate of 5 wt. % Fe, but a slightly higher average friction coefficient (μₛₛ=0.19). The composite filled with 5 wt. % FeCo achieved a steady-state wear rate of 2.8×10⁻⁷ mm³/Nm and an average friction coefficient of 0.21, the lowest wear rate of all composites tested, and a 100×-1000× reduction in wear compared to the Co and Fe composites, respectively. The wear rates for all three PTFE composites are shown in FIG. 3A and tabulated in Table 1. An inverse relationship between friction coefficient and wear rate was observed for all samples tested. All composite samples exhibited lower wear rates when compared to the unfilled PTFE control.

TABLE 1
Steady-state wear Kₛₛ, steady state friction μₛₛ, for unfilled PTFE and
Fe, Co, and FeCo PTFE composites.

| Material | Kₛₛ (mm³/Nm) | μₛₛ |
|---|---|---|
| 5 wt. % Fe | 1.8 ± 0.01 × 10⁻⁴ | 0.17 ± 0.01 |
| 5 wt. % Co | 7.4 ± 0.09 × 10⁻⁵ | 0.19 ± 0.01 |
| 5 wt. % FeCo | 2.8 ± 0.10 × 10⁻⁷ | 0.21 ± 0.01 |
| Unfilled PTFE | 7.8 ± 0.01 × 10⁻⁴ | 0.18 ± 0.01 |

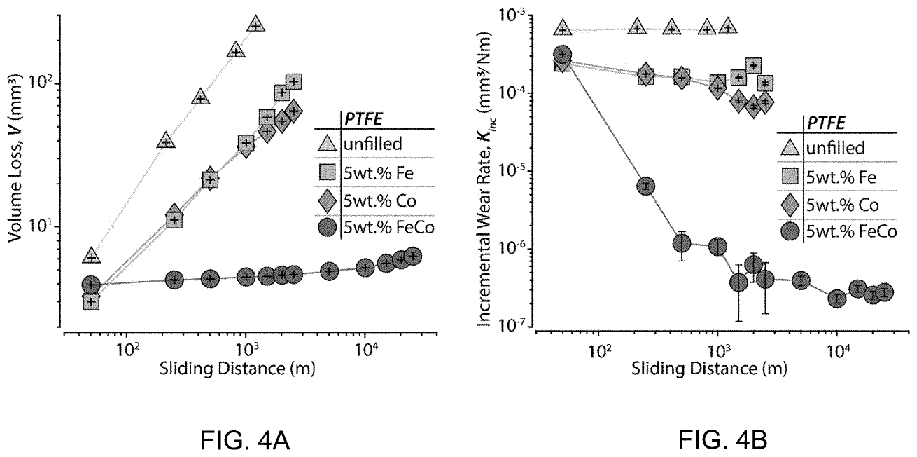

Wear testing of the PTFE-Fe and PTFE-Co samples was concluded after 50 k sliding cycles (2.5 km distance) due to high wear rates causing excessive volume loss. As shown in FIG. 4A, the volume loss of the PTFE-Fe sample is linear on a log-log plot of the sliding distance vs. volume loss. There was no observable run-in behavior observed for the PTFE-Fe sample which achieved steady-state wear in the early stages of testing. This constant wear rate behavior can be observed in FIG. 4B and is shown by an unchanged incremental wear rate of the PTFE-Fe sample over its entire sliding distance except for minor fluctuations. The PTFE-Co sample showed minor run-in in the first 1km of sliding, after which the incremental wear rate of the sample became constant (FIG. 4B) and a steady-state wear (7.4×10⁻⁵ mm³/Nm), ˜2× lower than the PTFE-Fe sample and 10× lower than the unfilled PTFE sample was achieved.

Testing of the PTFE-FeCo sample was carried out for 500 k sliding cycles (50 km), 10× longer than the PTFE-Fe and PTFE-Co samples. After the first 1 k sliding cycles, the PTFE-FeCo sample experienced a high amount of volume loss (˜4 mm³) (FIG. 4A), more than PTFE-Fe (˜3 mm³) or PTFE-Co (˜3.2 mm³). After 1 k sliding cycles, the incremental wear rate of the PTFE-FeCo sample dropped ˜100× over the following 250-500 m of sliding, shown in FIG. 4B. After 1.5 km of sliding, the PTFE-FeCo sample reached incremental wear rates on the order of 10⁻⁷ mm³/Nm which were sustained for the rest of the experiment, achieving a steady-state wear rate of 2.8×10⁻⁷ mm³/Nm. The steady-state wear behavior after 15 km of sliding can be observed in FIG. 4A, which shows a linear relationship with volume loss resulting in a constant incremental wear rate (FIG. 4B).

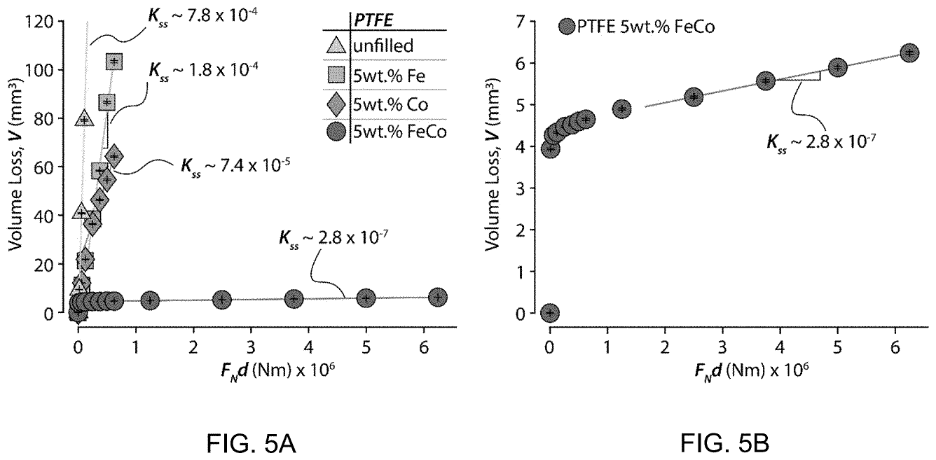

The run-in behavior of the PTFE-FeCo sample can be more closely inspected by plotting the volume loss over F_{N}d, shown in FIGS. 5A and 5B. The total volume loss of the PTFE-Fe and PTFE-Co over the first 50 k sliding cycles (2.5 km) was 1-2 orders of magnitude higher than that of the PTFE-FeCo sample. The steady state wear rates of each sample are denoted by the lines plotted in FIG. 5A. The significant differences in the steady state wear performance and overall volume loss of the samples causes the plotted steady state wear of the PTFE-FeCo sample to appear almost flat in comparison to the other samples. FIG. 5B plots the volume loss over F_{N}d for only the PTFE-FeCo. The transient period of volume loss occurs in the first few thousand cycles of sliding, after which linear volume loss behavior is observed and the steady state wear can be calculated.

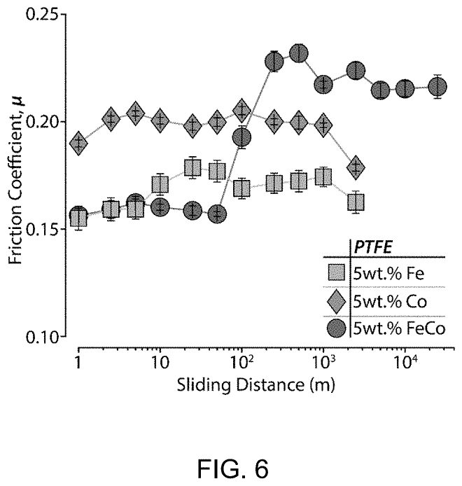

A relationship between sliding distance and friction coefficient is observed when plotting the friction coefficient over the sliding distance, as shown in FIG. 6. The average friction coefficient was determined for logarithmically increasing sliding distances (1 m , 2 m, 5 m, 10 m, 20 m, 50 m, 100 m, etc.). A transition from a low friction coefficient (μ˜0.15-0.16) to higher friction coefficient (μ˜0.21-0.23) for the PTFE-FeCo sample is observed around 100 m of sliding and is indicated by a sharp increase in the coefficient of friction. The increase in the coefficient of friction appears to coincide with the incremental wear rate of PTFE-FeCo achieving an incremental wear rate on the order of 10⁻⁷ mm³/Nm. The friction coefficients of the PTFE-Fe (μ˜0.17) and PTFE-Co (μ˜0.20) samples are lower than the final friction coefficients of the PTFE-FeCo sample, and only experience minor fluctuations throughout testing.

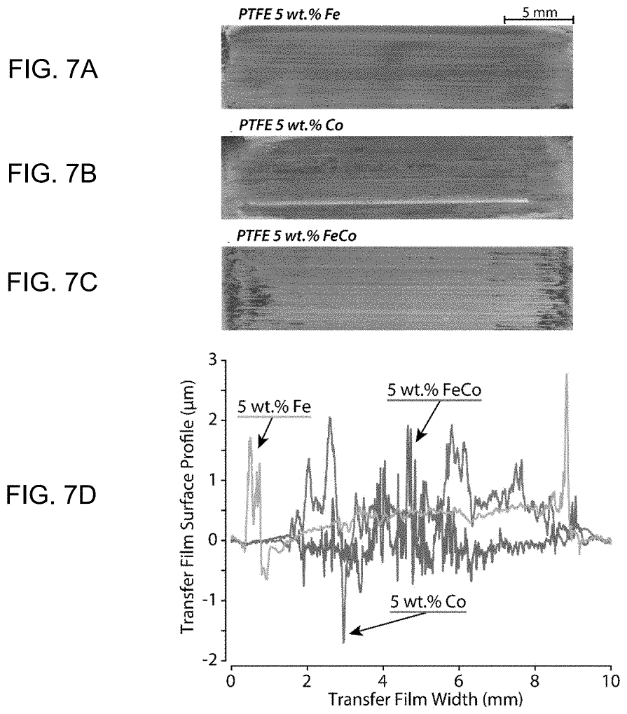

Optical images (FIGS. 7A-7C) and profilometry scans (FIG. 7D) of the transfer films formed by the Fe, Co and FeCo-filled PTFE samples show distinct differences in color, thickness, and uniformity. The PTFE-Fe transfer film is thick, uniform, and rusty in color. The PTFE-Co transfer film is patchy, and the pin has caused deep scratching into the transfer film and metal substrate. The transfer film of the PTFE-FeCo sample is a combination of the constituent element transfer films - rusty in color like the PTFE-Fe transfer film and less uniform like the Co transfer film. The PTFE-FeCo transfer film also shows deposition of material at the reversals, which does not appear in the other transfer films.

### Infrared (IR) Spectroscopy

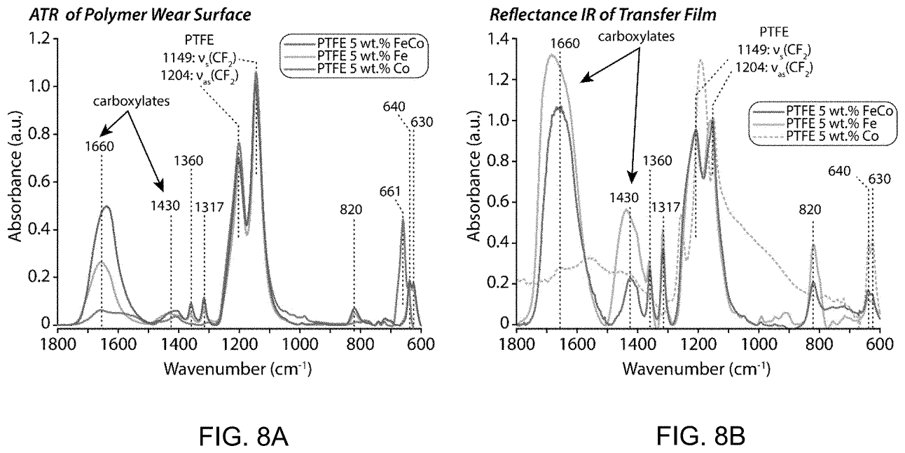

Attenuated total reflectance infrared (ATIR) spectra of the polymer wear surface of the Fe, Co, and FeCo filled PTFE polymer pins were collected and normalized to the 1149 cm⁻1 peak, the symmetric stretch of CF₂ which is a characteristic peak of PTFE (FIG. 8A). All three samples showed similar —CF₂-peaks at 1204 cm⁻¹ and 1149 cm⁻¹. Peaks at 1360 and 1317 cm⁻¹ indicate shortened PTFE chains and are only present in the Fe and FeCo samples. See H. S. Khare et al., J. Phys. Chem. C 119 (29), 16518 (2015); J. L. Lauer et al., Tribol. Trans. 31 (2), 282 (1988); and H. Vanni and J. F. Rabolt, J. Polym. Sci. B: Polym. Phys. 18 (3), 587 (1980). Iron oxide is present in both the Fe and FeCo samples, as indicated by the 820 cm⁻¹ peak. The characteristic cobalt oxide peak at 661 cm⁻¹ is only observed in the Co sample. The peaks at 630 and 640 cm⁻¹ can be attributed to CF2 wagging and chain stretching of PTFE, respectively. See C. Y. Liang and S. Krimm, J. Chem. Phys. 25 (3), 563 (2004). While this region looks identical in the Fe and FeCo samples, the Co sample only shares the 640 cm⁻¹ peak. Peaks at 1660 cm⁻¹ and 1430 cm⁻¹ regions indicate the presence of perfluorinated carboxylates, which are referred to as tribochemical species (i.e., a new chemical species formed during sliding). See K. E. Van Meter et al., Macromolecules 55 (10), 3924 (2022); K. L. Harris et al., ACS Macromol. 48 (11), 3739 (2015); K. L. Campbell et al., Macromolecules 52 (14), 5268 (2019); A. A. Pitenis et al., Tribol. Lett. 57 (1), 1 (2015); M. Przedlacki and C. Kajdas, Tribol. Trans. 49 (2), 202 (2006); C. K. Kajdas, Tribol. Int. 38 (3), 337 (2005); and D. R. Haidar et al., J. Phys. Chem. C 122 (10), 5518 (2018). The FeCo polymer wear surface has slightly less, and the Co film had little carboxylates present in the polymer wear surface.

The chemical composition of the transfer films deposited on the counter sample during sliding was measured using reflectance IR at the conclusion of testing. The spectra was normalized to the 1149 cm⁻¹ CF₂ peak (FIG. 8B). Similar CF₂ peaks at 1149 cm⁻¹ and 1204 cm⁻¹ and shortened PTFE chains at 1360 and 1317 cm⁻¹ were observed in both the Fe and FeCo transfer films. The Fe and FeCo transfer films also have high levels of carboxylates present, shown by the peaks at 1660 cm⁻¹ and 1430 cm^{-1.} The Fe transfer film had higher levels of carboxylates and iron oxides (820 cm⁻¹) present in the transfer films when compared to the FeCo transfer film. The spectra signal for the Co transfer film was very weak in comparison to the Fe and FeCo signals, most likely due to abrasion of the transfer film during sliding. This signal weakness made the spectra difficult to normalize and perform baseline subtraction, leading to some error in the measurement. It is worth noting that the Co transfer film had peaks in the CF2 peak locations as well as a peak near the 1250 cm⁻¹ region. This peak is not frequently observed experimentally, but is typically associated with very thin transfer films with aligned PTFE chains and can be found in PTFE transfer films after a single sliding cycle. See K. L. Harris et al., ACS Macromol. 48 (11), 3739 (2015); J. L. Lauer et al., Tribol. Trans. 31 (2), 282 (1988); and R. E. Moynihan, J. Am. Chem. Soc. 81 (5), 1045 (2002). This could point to a very thin film of PTFE-Co that is suffering from abrasion, removal, and retransfer during sliding.

### Discussion

PTFE filled with 5 wt. % FeCo microparticles exhibited a steady-state wear rate of 2.8×10⁻⁷ mm³/Nm, ˜100× lower than PTFE filled with 5 wt. % Co (7.4×10⁻⁵ mm³/Nm) and ˜1000× lower than PTFE filled with 5 wt. % Fe (1.8×10⁻⁴ mm³/Nm). The ultralow wear rate of PTFE-FeCo coincides with a well-developed transfer film and robust polymer wear surface, including the formation of tribochemical species. The evolution of the sliding interface due to tribochemical changes are observed by the increase in the coefficient of friction (μ˜0.22) at 100 m of sliding (FIG. 6) and the subsequent decrease in volume loss and the incremental wear rate (FIGS. 4A and 4B). This is similar to the transition in the coefficient of friction and wear rate in ultralow wear PTFE-alumina, which has previously been attributed to development of transfer films and resulting increases in carboxylate accumulation and attractive forces at the interface. See B. A. Krick, “Exploring the Ultra-Low Wear Behavior of Polytetrafluoroethylene and Alumina Composites,” Univ. of Florida (2012). The PTFE-Fe composite shows a minor increase in the coefficient of friction at 10 m of sliding (FIG. 6) yet does not experience a change in wear rate which is high (˜10⁻⁴ mm³/Nm) throughout the duration of the test.

IR spectroscopy of the polymer wear surfaces shows (FIGS. 8A and 8B) that the PTFE-FeCo sample accumulated the most carboxylates, indicated by the shoulders at 1725-1675 cm⁻¹ and 1430 cm⁻¹, as well as experienced the most chain shortening (peaks at 1360 and 1317 cm⁻¹). Shortening of PTFE chains has been observed in low wear PTFE composites and is often paired with the formation of tribochemical species due to the reactivity of the RF-CF2 radicals on the chain ends. See S. K. Biswas and K. Vijayan, Wear 158 (1-2), 1 (1984); B. A. Krick et al., Tribol. Int. 51, 42 (2012); K. L. Harris et al., ACS Macromol. 48 (11), 3739 (2015); H. S. Khare et al., J. Phys. Chem. C 119 (29), 16518 (2015); K. L. Campbell et al., Macromolecules 52 (14), 5268 (2019); A. A. Pitenis et al., Tribol. Lett. 57 (1), 1 (2015); and H. Vanni and J. F. Rabolt J. Polym. Sci. Polym. Phys. Ed. 18 (3), 587 (1980). Accumulation of carboxylates provides anchor sites to metallic substrates creating well adhered transfer films and polymer wear surfaces. See B. A. Krick et al., Tribol. Int. 51, 42 (2012); B. A. Krick et al., Tribol. Int. 95, 245 (2016); K. L. Harris et al., ACS Macromol. 48 (11), 3739 (2015); A. A. Pitenis et al., Tribol. Lett. 57 (1), 1 (2015); and K. I. Alam et al., Wear 482-483, 203965 (2021). Interestingly, tribochemical infrared peaks are observed in both the FeCo and Fe samples, yet the tribological behavior is vastly different. The transfer films of the Fe and FeCo samples contained high amounts of carboxylates and iron oxide, with the Fe transfer film having higher levels when compared to the FeCo transfer films. The presence of carboxylates and PTFE chain scission in the Fe sample polymer wear surface and transfer film are indicative of a low wear sample yet the PTFE-Fe has a wear rate (1.8×10⁻⁴ mm³/Nm) on the order of virgin PTFE (˜4×7×10⁻⁴ mm³/Nm). See K. R. Makinson and D. Tabor, Nature 202 (1), 464 (1964); T. A. Blanchet and F. E. Kennedy, Wear 153 (1), 229 (1992); and K. E. Van Meter et al., Macromolecules 55 (10), 3924 (2022). The accumulation of carboxylates in a polymer wear surface of a PTFE composite with a high wear rate can be rationalized by considering competition between shear-induced carboxylate formation and wear events which remove interfacial species. See K. L. Alam and D. L. Burris, J. Phys. Chem. C 125 (35), 19417 (2021). A possible explanation for the observed carboxylate accumulation in high wear PTFE-Fe running and transfer films is due to the reactive nature of iron causing further degradation of PTFE polymer chains at the sliding interface in conjunction with shear-induced degradation and chain scission. See T. Onodera et al.,J. Phys. Chem. C 120 (20), 10857 (2015).

A second explanation for the PTFE-Fe behavior stems from relationships between wear and surface energy. See J. Ye et al., J. Phys. Chem. C 124 (11), 6188 (2020). Surface energy gradients between the polymer pin and the transfer film resulting from iron oxide and carboxylates in the transfer film drive material transfer from the polymer pin (i.e., low to high surface energy). See J. Ye et al., J. Phys. Chem. C 124 (11), 6188 (2020). Though gradients in the surface energy can be beneficial for forming stable transfer films, large gradients can cause excessive wear. The high levels of carboxylates found in the transfer films of the PTFE-Fe sample indicate that there is significant degradation of PTFE chains and subsequent increases in the films surface energy as a result. It is possible that the PTFE-Fe sliding interface has an extremely high surface energy gradient that can result in high material transfer and wear of the pin. In the case of the PTFE-Co sample, the wear rate was ˜2× lower than the PTFE-Fe sample (7.4×10⁻⁵ mm³/Nm) yet the PTFE-Co polymer wear surface had the lowest amount of carboxylates present and had relatively small 1360 and 1317 cm⁻¹ PTFE chain shortening peaks. The signal of the IR spectra in the transfer film was exceptionally low, with no observable carboxylates indicating that there was very little material transferred and retained on the counter sample. The lack of tribochemical species and degraded PTFE chains could explain the poor wear rate which is only slightly better than virgin PTFE.

Microparticle fillers for PTFE composites must meet two criteria to achieve ultralow wear rates: (1) particles break up during sliding and accumulate at the sliding interface promoting formation of carboxylates, and (2) sub-surface particles need to arrest crack formation and prevent large-scale delamination events. PTFE filled with iron or cobalt microparticles appear to lack one of the two criteria required for ultralow wear, while PTFE-FeCo meets both.

Interestingly, the particle morphology and size analysis of the Fe, Co, and FeCo particles do not correspond to the working mechanistic hypothesis for other ultralow wear materials like PTFE-alumina. In the PTFE-alumina wear system, the lowest wear particles are microscale particles with nanoscale primary particles or features, and are porous enough to break down during sliding. See B. A. Krick et al., Tribol. Int 95, 245 (2016). Microscale, dense particles used as filler materials in PTFE tend to abrade the countersurface and disrupt transfer film formation. See B. A. Krick et al., Tribol. Int. 95, 245 (2016); D. L. Burris et al., Macromol. Mater. Eng. 292 (4), 387 (2007); and S. Bahadur, Wear 245 (1-2), 92 (2000). Nanoscale particles lack the ability to reinforce the bulk polymer, and do not result in ultralow wear. See B. A. Krick et al., Tribol. Int. 95, 245 (2016). In the case of the Fe, Co, and FeCo powders, the particle size and apparent agglomerate morphology of the Fe and Co particles (FIGS. 1A, 1B, and 1F) would indicate that they could significantly reduce the wear rate of PTFE through reinforcement of the bulk polymer while also breaking down and accumulating at the sliding interface to reinforce tribofilms. By the same logic, the large, dense, micron scale FeCo particles (FIGS. 1C and 1F) would be expected to marginally improve the wear rate of PTFE but ultimately abrade the tribofilms and countersurface. However, the exact opposite wear behavior is observed when testing these filler particles.

The unexpected wear behavior of the Fe, Co, and FeCo microparticles indicates that particle size and morphology are not always the dominating factor in promoting ultralow wear. Particle friability and chemical interactions with reactive elements appears to dominate. While Fe promotes the formation of carboxylates and PTFE chain shortening, the particles cannot prevent sub-surface cracking and delamination, driving PTFE-Fe to be high wear. It seems that Fe microparticles can react with PTFE, causing excessive degradation at the sliding interface. Cobalt microparticles improved the wear rates of PTFE by reinforcing the bulk polymer and arresting sub-surface cracking and delamination events. Hard micro-scale particles have been shown to incrementally improve the wear rate of PTFE. See B. A. Krick et al., Tribol. Int. 95, 245 (2016); and W. G. Sawyer et al., Wear 254 (5-6), 573 (2003). Limited improvements in wear rates are a result of hard particles not breaking into smaller particles that accumulate at the surface during sliding but instead scratch the countersurface (FIG. 7B) and disrupt the formation of transfer and polymer wear surfaces. See M. A. Sidebottom et al., ACS Appl. Mater. Interfaces 14 (48), 54293 (2022). While alumina fillers are friable due to their porous, agglomerate nature, the agglomerate Co particles utilized in this study do not appear to be friable enough to promote ultralow wear. See M. A. Sidebottom et al., ACS Appl. Mater. Interfaces 14 (48), 54293 (2022). Significant abrasion of the counter sample and transfer film could indicate that the Co particle are hard agglomerates that have difficulty breaking up during sliding. Additionally, even if the Co agglomerates are able to break up during sliding, the primary particles in the Co powder are ˜1 μm in size, and at the smallest ˜700 nm (FIGS. 1A and 1D-1F). Compared to the primary particles and nanoscale features observed in alumina fillers that promote ultralow wear (˜40×80 nm), the Co primary particles are 10-20× larger, and are still capable of abrading the counter sample and tribofilms. See B. A. Krick et al., Tribol. Int. 95, 245 (2016).

The superior wear performance of the PTFE-FeCo sample is attributed to the same low-wear promoting mechanisms present in low filler wt. % composites like PTFE-alumina, but with vastly different particle morphology and mechanical properties. Micro-scale FeCo particles reinforce the PTFE matrix and prevent sub-surface cracking and delamination. The inherent brittleness of FeCo alloys is a benefit for PTFE composites as it allows for the FeCo particles to break down into smaller particle sizes and accumulate during sliding, despite the dense, microscale state of the particles. Binary Fe-50Co is characterized by low yield strength (200-300 MPa) and low strain-to-failure (0-6%) in tension, depending on the alloy processing thermal history. See T. Sourmail,Prog. Mater. Sci. 7, 816 (2005); and E. P. George et al., Mater. Sci. Eng. 329-331, 325 (2002). Specifically, the mechanical properties are significantly influenced by a characteristic phase transformation at ˜730 ° C. in which a chemically disordered bcc lattice transitions to a chemically ordered B2 structure, impeding dislocation accommodation mechanisms during plastic deformation. See R. S. Sundar et al., Int. Mater. Rev. 50 (3), 157 (2005); T. Sourmail, Prog. Mater. Sci. 7, 816 (2005). The high-temperature of the disorder-order transition leads to high-atomic mobility, making it difficult to avoid the ordered phase through conventional processing and can only be suppressed through rapid quenching from the high-temperature bcc phase region at rates in excess of 1000° C./sec. See D. W. Clegg and R. A. Buckley, Met. Sci. J. 7 (1), 48 (1973). FeCo was utilized as a gas atomized powder for a filler material and likely possesses some extent of the high-temperature disordered bcc phase due to rapid solidification associated with the powder processing. Note that cooling and solidification rates in gas atomization are unknown for the particular FeCo powder evaluated in this study, but previous literature has suggested cooling rates between 102 and 108° C./sec for gas atomization powder processing, which is sufficiently rapid to promote at least partial, if not full, chemical disorder in FeCo. See D. W. Clegg and R. A. Buckley, Met. Sci. J. 7 (1), 48 (1973); and A. M. Mullis et al., Mater. Sci. Metall. Mater. Trans. B 44 (4), 992 (2013). Nonetheless, the powder filler itself is anticipated to have very limited ductility. Therefore, the intrinsically brittle nature of the FeCo alloy is likely enabling the particles to break down as a result of sliding, subsequently accumulating in and reinforcing developing tribofilms. Without the brittle nature of the FeCo alloy, these filler particles would be expected to only promote marginal improvements in the wear of PTFE while also abrading the countersurface and tribofilms, inhibiting ultralow wear behavior.

The present invention has been described as an ultra-low wear magnetic polymer composite. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A low-wear magnetic polymer composite, comprising magnetic alloy particles dispersed in a perfluoropolymer matrix.

2. The low-wear magnetic polymer composite of claim 1, wherein the magnetic alloy has a yield strength of less than 300 MPa and a strain-to-failure of less than 6%.

3. The low-wear magnetic polymer composite of claim 1, wherein the magnetic alloy comprises an iron-cobalt intermetallic alloy.

4. The low-wear magnetic polymer composite of claim 3, wherein the iron-cobalt intermetallic alloy further comprises vanadium, chromium, niobium, molybdenum, and/or nickel.

5. The low-wear magnetic polymer composite of claim 1, wherein magnetic polymer composite comprises between 1 and 50 wt. % magnetic alloy particles.

6. The low-wear magnetic polymer composite of claim 1, where the size of the magnetic alloy particles are greater than 100 nm and less than 100 μm.

7. The low-wear magnetic polymer composite of claim 1, where the perfluoropolymer comprises polytetrafluoroethylene, perfluoroalkoxy alkane, fluorinated ethylene-propylene, or polychlorotrifluoroethylene.

8. The low-wear magnetic polymer composite of claim 1, wherein the magnetic polymer composite has a steady-state wear rate of less than 1×10⁻⁶ mm³/Nm.
